(19) United States
(12) Patent Application Publication
(10) Pub. No.: US 2018/0315332 A1
(43) Pub. Date: Nov. 1, 2018

(54) METHOD OF INCENTIVIZING USERS TO ENGAGE IN EDUCATIONAL EXPERIENCES

(71) Applicants: Alexandra Rose HUFFMAN, Chatham, NJ (US); Suzette REDLING, Chatham, NJ (US)

(72) Inventors: Alexandra Rose HUFFMAN, Chatham, NJ (US); Suzette REDLING, Chatham, NJ (US)

(21) Appl. No.: 16/012,486

(22) Filed: Jun. 19, 2018

Related U.S. Application Data
(63) Continuation of application No. 15/411,495, filed on Jan. 20, 2017.
(60) Provisional application No. 62/367,878, filed on Jul. 28, 2016.
(60) Provisional application No. 62/286,011, filed on Jan. 22, 2016.

(51) Int. Cl. G09B 7/08; G09B 5/08; G09B 7/04; G09B 7/07; G06F 21/62; G06Q 30/02

(52) U.S. Cl. CPC G09B 7/08; G09B 5/08; G09B 7/04; G06Q 30/02; G06F 2221/2137; G06F 2221/2149; G06F 21/62; G09B 7/07

(57) ABSTRACT

A computerized method of incentivizing users to engage in educational experiences is provided. The method uses both negative reinforcement by preventing the users form accessing preselected restricted content as well as positive reinforcement by allowing the children to engage in an unlimited amount of educational experiences so that they may earn tangible items in the real-world. Additionally, the ability for third parties to upload their own educational experiences to be used within the method as well as the ability for them to provide some or all of the real-world items that the users can earn, providing unique business opportunities in the educational space.

### CLAIM OF PRIORITY

This application is a continuation of U.S. patent application Ser. No. 15/411,495, filed on Jan. 20, 2017, which claims priority to U.S. Provisional Patent Application No. 62/286,011 filed on Jan. 22, 2016, entitled “Method of Controlling Access to Software Applications” and U.S. Provisional Patent Application No. 62/367,878 filed on Jul. 28, 2016, also entitled “Method of Controlling Access to Software Applications,” the contents of all of which are hereby incorporated by reference, including their specifications.

### NOTICE OF COPYRIGHTS AND TRADE DRESS

A portion of the disclosure of this patent document contains material which is subject to copyright or trade dress protection. This patent document may show and/or describe matter that is or may become trade dress of the owner. The copyright and trade dress owner has no objection to the facsimile reproduction by anyone of the patent disclosure, as it appears in the Patent and Trademark Office patent files or records, but otherwise reserves all copyright and trade dress rights whatsoever.

### FIELD OF THE EMBODIMENTS

The invention and its embodiments relate to a method and its system of implementation for incentivizing users to engage in educational experiences. In particular, the method and its system of implementation incentivize users through both positive and negative reinforcement.

### BACKGROUND

It is well known that the majority of children need some encouragement to study academic subjects. While there are many different ways in which people attempt to get children to study, one popular method is the gamification of studying. That is, turning the act of studying into a fun game, so that the child will have a desire to engage in studying. With the rise of video games, games such as Math Blaster® and Mario Typing® were early examples of the attempt to create educational games that are as entertaining as recreational games. As the budgets for recreational games rose while the budget for educational games remained mostly stagnant, the recreational games became far more enticing to play, leaving the users with little reason to play the educational games.

In an attempt to close this gap, some solutions have been provided that prevent the child from playing the recreational video games until an educational (or other edifying task) is performed. While predicating the use of recreational games on the use of educational games may help children in the short-term, the lack of positive reinforcement in playing educational games can incentivize children to find alternative ways around the lock. The cycle of punishment merely incentivizes the child to find ways around the lock on recreational games, as there is no positive reinforcement with playing the educational game. Purely using negative reinforcement approach does not create long-term habits that result in the child wanting to play the educational games. If one were to provide a positive benefit from engaging with the educational games in addition to the negative consequence of not engaging in said educational games, a two-pronged incentivization system could be constructed, yielding far more effective long-term results than the one-pronged alternative.

As such, there is a need for a system that uses both “the carrot” (positive reinforcement) and “the stick” (negative reinforcement) to incentivize users (e.g. children) to engage in educational experiences, such that, they will want to engage in the educational experiences without fear of “the stick,” regardless of what “the stick” may be.

Further, continuously providing updated educational content can be a challenge without expending large amount of dollars merely on content generation, thus creating a need for the ability for third parties to upload educational content to be used in the educational experiences. Moreover, if third parties are going to be providing additional content, there is potential for them to provide all or part of the “carrot” in an attempt to help their own business.

Review of Related Technology:

International Patent Application No.: WO 2016160959 pertains to a device, comprising at least one processor and at least one computer-readable storage medium having encoded thereon executable instructions that, when executed, cause the at least one processor to: monitor a user's usage of the device; in response to determining that an amount of time the user has been using the device has reached a selected limit for usage time, activate a home screen application to restrict the user's access to the device, wherein the home screen application is programmed to prompt the user to demonstrate at least one achievement; and in response to determining that the user successfully demonstrated at least one achievement, allow the user to regain access to the device.

United States Patent Publication No.: 2016/0335424 pertains to methods, systems, and apparatus, including computer programs encoded on a computer storage medium, for unlocking time to non-educational tasks on devices. In one aspect, a method includes receiving an indication that a user has completed the first educational task; calculating a first educational value score for the first educational task; calculating a first amount of earned non-educational time based on the first educational value score and adding the first amount to a total amount of earned non-educational time maintained in a user profile of the user; identifying a second educational task of the plurality of educational tasks; receiving an indication that the user has completed the second educational task; and in response, updating the total amount of earned non-educational time associated with the user profile of the user.

OurPact, developed by Eturi Corporation, enables the remote management of children's time on the internet and app access through “at-a-touch blocking”, or automated schedules. OurPact requires two devices: a parent device, and one or more child devices, OurPact's iOS or web app is accessed on the parent device, and a management profile is installed on the child devices. This enables mobile, remote management to meet the needs of parents.

U.S. Pat. No. 5,743,746 pertains to a computer-aided-educational system and method for rewarding a student when the student attains a milestone in a subject. The subject is divided into line-items with at least one line-item being more difficult than another line-item. In one embodiment, the system includes a milestone setter, a performance analyzer, a reward determinator and a reward generator. The milestone setter sets a number of milestones, with each milestone being related to a line-item, and with an instructor providing inputs to the milestone setter to set each line-item that has a milestone to be reached. The performance analyzer coupled to the milestone setter determines whether the student has reached a milestone. The reward determinator coupled to the performance analyzer determines a reward for the student if the performance analyzer indicates that the student has reached a milestone. The reward generator, coupled to the reward determinator, generates the reward for the student.

U.S. Pat. No. 6,733,296 pertains to a learning system includes a student station that holds a learning session for a student. An incentive controller delivers a redeemable electronic token to the student station when the student satisfies a predefined incentive criterion associated with the learning session.

U.S. Pat. No. 8,676,619 pertains to a computer apparatus and methods of the preferred embodiment that uses computer technology in a unique way to motivate children to devote more time to educational and cultural enrichment. In the preferred embodiment, educational material is provided at a child's local computer under control of a central computer system connected to it over a computer network. On completing a particular educational task, the child is rewarded with a certain number of points. Points that the child accumulates are stored centrally, and at least some of the points can be redeemed towards the purchase of goods and services offered through the system of the preferred embodiment by its commercial participants. The purchasing transactions are also administered by the central computer. Parents, preferably, use the system to support their children's purchasing activity financially and to select content available for presentation to the child. In other embodiments, the disclosed apparatus and methods can be used for purposes unrelated to education of children, and distribution of functionality between the central and local computers may be different, including wholly local implementations.

U.S. Pat. No. 9,129,135 pertains to systems, methods, devices, and computer program products are described for controlling access to electronic applications by a user. A request may be received (e.g., from a user) to access an electronic application. The availability of points, credits, or time for the particular user may be determined, and access to the electronic application granted or denied based on the determination. User identity may be verified through biometric data, with such verification repeated at periodic or random intervals. Access may be restricted based on a permission level of a particular authority that has responsibility for all or a portion of the user's activities during a particular time period. Access may also be restricted based on the location of the user at the time of the access request.

United States Patent Publication No.: 2010/0285871 pertains to an online parental control system is provided in connection with ‘activity for credit’ systems where a child earns credits into an account by performing prescribed activity. The credit earned may be spent on goods and services, and in particular in on-line transactions. Both spending and earning activity are controlled by a parent or other guardian by way of a special account login. A parent may designate earning parameters and further spending rules to control activity of her child. Accordingly, and on-line control system is coupled via the Internet to a user community including a child member and a parent member. A member account includes a parent facility with a rule library and lesson library. By way of a parent control module, a parent set parameters of the member account which cannot be manipulated by the child. Thereafter, the member account performs in a manner suitable to the parent in view of her selections.

United States Patent Publication No.: 2015/0007307 pertains to network-based methods for remotely locking and unlocking designated features on a user's electronic computing device (e.g. internet, games, SMS, email) while keeping other software functioning for the user to perform selected activities (e.g. quizzes). Unlocking the device may be based upon a condition, such as the user achieving an objective (e.g. answered quiz questions, received a high class grade, etc.), or the passage of time (e.g. duration of a test), or detecting the device GPS coordinates. The device may be locked/unlocked remotely via a gateway server communicating via a network with the device, or directly via a passcode utilizing a software module loaded on the device. The lock may be overridden, such as in emergency situations to allow the user to call 911 or their emergency contacts, wherein a third party is electronically notified; or, unlocked by the user with the passcode when a selected activity is successfully completed.

For the foregoing reasons, there is a need for a method that incentivizes users to engage in educational experiences that offers both “the carrot” and “the stick”, and provides the opportunity for third parties to provide educational content and all or part of “the carrot” in a way that benefits the business of said third party.

While these units may be suitable for the particular purpose employed, or for general use, they would not be as suitable for the purposes of the present disclosure as disclosed hereafter.

In the present disclosure, where a document, act, or item of knowledge is referred to or discussed, this reference or discussion is not an admission that the document, act, item of knowledge, or any combination thereof that was known at the priority date, publicly available, known to the public, part of common general knowledge or otherwise constitutes prior art under the applicable statutory provisions; or is known to be relevant to an attempt to solve any problem with which the present disclosure is concerned.

While certain aspects of conventional technologies have been discussed to facilitate the present disclosure, no technical aspects are disclaimed. It is contemplated that the claims may encompass one or more of the conventional technical aspects discussed herein.

### SUMMARY

The present invention provides a computerized method and system which implements said method, that satisfies this need. The present disclosure provides for a computerized method for incentivizing a user to engage in educational experiences. The method starts with first obtaining a list of preselected restricted content; the restricted content being ordinarily accessible by the internet-enabled electronic device. After the list has been obtained, an educational count and an educational quota for the user is obtained. The educational count is a redeemable running tally of the amount of educational experiences the user has participated in, and the educational quota is equal to the value of the educational count required to access the restricted content. The method then determines whether the user's educational count is below the educational quota. If so, the method prevents access to the restricted content and subsequently provides an educational game that can be played by the user to raise their educational count. When the user successfully completes the educational game, the method raises their educational count. In some embodiments, the method then repeats the step of determining whether the user's educational count is below the educational quota. If so, access to the restricted content is prevented and the user is presented with another educational game. In some embodiments this is the same game, and in other embodiments this is a different game. This is repeated until the user gives up or the educational count is raised above the educational quota. When the educational count is raised above the educational quota the user may lower their educational count by an amount equal to the educational quota to have the method grant access to the restricted content.

In a preferred embodiment, the preselected restricted content is preselected by a second user from a list of ordinarily accessible content. In another related embodiment, the educational quota is set by the second user. In yet another related embodiment, the amount of time is set by the second user. For example, the first user may be a child and the second user may be the parent of said child. In various embodiments, the educational game is selected from the group consisting of a math game, a puzzle game, a spelling game, a quiz game, a coloring game, and a reading game, where all of the aforementioned games are in accordance with the description contained herein.

In a highly preferred embodiment, the educational game is imported into the system by a remote source such as a third party or advertising partner. In another embodiment, the method continues and provides the user with a register of a plurality of tangible items; each tangible item having a respective item value. The method then obtains a set of rules that defines a ratio between an educational count and the item value. Using this ratio, the user is then able to redeem all or part of their educational count in exchange for one or more of the tangible items; based on the ratio obtained by the method in the previous step. In another highly preferred embodiment, all or part of the plurality of tangible items is provided by the remote source such as a third party or advertising partner.

In various embodiments, the method generates a report containing information regarding the user's interaction with the educational game. This can include success rate, time spent on each problem, and other desirable items of information. Preferably, this report is available to the second user.

The present disclosure also provides for an apparatus for incentivizing a user to engage in educational experiences. The apparatus includes a client-server computer system including a server computer connected to a plurality of client computers over a wide area network. This server computer system stores the educational count and the educational quota for at least one user, a register of tangible items, each tangible item having a respective item value, and a set of rules that define a ratio of educational count to item value; receives updates to the educational count and educational quota from the client computer; and generates a report containing information pertaining to the user playing the educational game. The client computer provides at least one educational game which can be used to increase the educational count; identifies what information is restricted content; locks the restricted content until the educational quota has been met; sends updates to the educational count and the educational quota to the server computer system; and unlocks the restricted content for a predetermined period of time when the educational quota has been met. In some embodiments, the server computer system also stores a plurality of question-and-answer sets for the educational game. In other embodiments, the server computer system receives a third-party educational game from a remote source; stores the third-party educational game; and sends data pertaining to the third-party educational to the client computer.

Additionally, the present disclosure also provides for an article of manufacture for incentivizing a user to engage in educational experiences. The article of manufacture features a set of application program interfaces embodied on a computer-readable medium for execution on a computer in conjunction with an application program that incentivizes a user to engage in educational experiences; a business interface that provides at least one service available to the user; a data sources interface that provides access to data stored on an external server; a resource access interface that parses data between the business layer and the data sources layer; and a security interface that provides access to at least one validated user and prevents access to at least one non-validated user. Preferably, the data stored on the external server is used for at least one question-and-answer set for use in the educational game. Some embodiments exist where the at least one service includes a service for reporting metrics on a user's performance to a second user.

The above embodiments provide for a method that incentivizes users, preferably children, to engage in educational experiences, preferably educational games. This method provides the benefit of providing both positive reinforcement of allowing children to earn tangible items, and negative consequences of not allowing the child to use restricted content until the educational game has been played a sufficient amount. Further, the method provides for the ability of third party providers to upload educational content and provide some or all of the tangible items that can be earned; for example, allowing the third party to, drive brand engagement or to unload surplus stock of certain items.

The present disclosure addresses at least one of the foregoing disadvantages. However, it is contemplated that the present disclosure may prove useful in addressing other problems and deficiencies in a number of technical areas. Therefore, the claims should not necessarily be construed as limited to addressing any of the particular problems or deficiencies discussed hereinabove. To the accomplishment of the above, this disclosure may be embodied in the form illustrated in the accompanying drawings. Attention is called to the fact, however, that the drawings are illustrative only. Variations are contemplated as being part of the disclosure.

Implementations may include one or a combination of any two or more of the aforementioned features.

These and other aspects, features, implementations, and advantages can be expressed as methods, apparatuses, systems, components, program products, business methods, and means or steps for performing functions, or some combination thereof.

Other features, aspects, implementations, and advantages will become apparent from the descriptions, the drawings, and the claims.

### BRIEF DESCRIPTION OF THE DRAWINGS

In the drawings, like elements are depicted by like reference numerals. The drawings are briefly described as follows.

FIG. 1 shows a flow chart of one embodiment of the method in accordance with the present disclosure.

FIG. 2 shows a flow chart of an alternative embodiment of the method in accordance with the present disclosure.

FIG. 3 shows a flow chart yet another embodiment of the method in accordance with the present disclosure.

FIG. 4 shows an embodiment of the apparatus in accordance with the present disclosure.

The present disclosure now will be described more fully hereinafter with reference to the accompanying drawings, which show various example embodiments. However, the present disclosure may be embodied in many different forms and should not be construed as limited to the example embodiments set forth herein. Rather, these example embodiments are provided so that the present disclosure is thorough, complete, and fully conveys the scope of the present disclosure to those skilled in the art. In fact, it will be apparent to those skilled in the art that various modifications and variations can be made in the present invention without departing from the scope or spirit of the invention.

### DESCRIPTION OF THE PREFERRED EMBODIMENTS

The preferred embodiments of the present invention will now be described with reference to the drawings. Identical elements in the various figures are identified with the same reference numerals.

Reference will now be made in detail to each embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

While the disclosure refers to exemplary embodiments, it will be understood by those skilled in the art that various changes may be made and equivalents may be substituted for elements thereof without departing from the scope of the disclosure. In addition, many modifications will be appreciated by those skilled in the art to adapt a particular instrument, situation, or material to the teachings of the disclosure without departing from the spirit thereof. Therefore, it is intended that the disclosure not be limited to the particular embodiments disclosed.

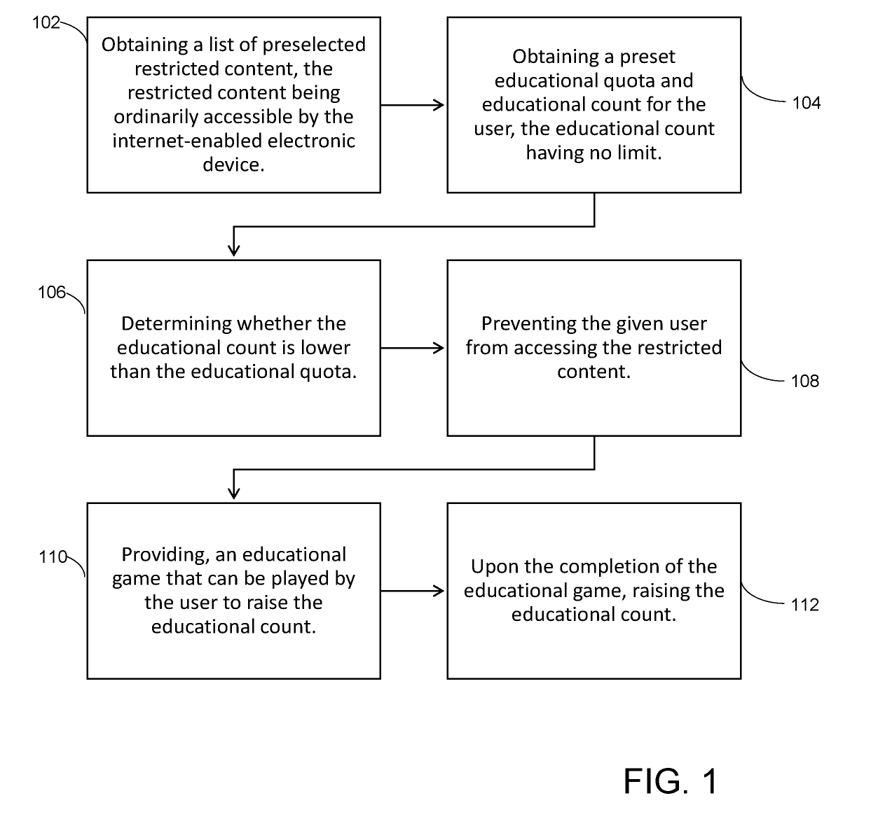

Referring to FIG. 1, a flow chart of one embodiment of the method of the present invention is shown whereby a user increases their educational count is shown. Here, step 102 consists of obtaining a list of preselected restricted content. The restricted content shall be content that is ordinarily accessible by the internet-enabled electronic device used in the method of incentivizing users to engage in educational experiences. This content may be an installed software application, an internet browser, a list of specific websites, or other related content. It should be noted that educational experiences typically refers to playing an educational game but may also consist of engaging with other educational content. It should also be noted that “internet-enabled electronic device” can be a smartphone, tablet, personal computer, smart television or any other “internet of things”-type of device. The restricted content is preselected, and is preferably preselected by a second user. For example, the first user could be a child and the second user could be the parent of the child. In step 104, the method obtains a preset educational quota and an educational count for the first user. The educational count has no limit. Preferably, the preset educational quota is preset by a second user. For example, this second user could be the parent of the first user. The educational quota represents an amount that the educational count must reach in order for the restricted content to be accessed. The educational count can have a wide variety of units, such as raw integers or rational numbers. In a preferred embodiment, the educational count is tracked in terms of an in-game currency, such as coins. In some embodiments, the in-game currency will also work in applications produced by third parties. In step 106, the method determines whether the first user's educational count is lower than their educational quota. If so, said user is prevented from accessing restricted content in step 108 and is subsequently provided with an educational game that can be played to raise that user's educational count in step 110. When said user successfully completes the educational game, their educational count is raised in step 112. In a highly preferred embodiment, the second user, such as a parent, will determine how many questions the first user must answer in the educational game.

For example, a second user, such as a parent, may begin by preselecting restricted content on the internet-enabled electronic device, such as a smartphone. Note that the method works if the second user wants to restrict access to content on their phone or on the first user's phone, such as a child of the second user. This is important as many parents have differing opinions as to what should be restricted and a uniform determination of what should be restricted does not truly serve the needs of the parents. After the restricted content has been preselected, the second user shall preset the educational quota for the first user. That is, the second user shall indicate how much educational experiences must be engaged in before the first user will be able to access the restricted content. Lastly, the second user should set how much time the restricted content should be unrestricted for when the first user redeems their educational count against their educational quota. After these factors have been set, the method will perform as described above. It should be noted that the method could be performed on the same device for multiple first users while being set up by a single second user, such as a parent with multiple children who share a device.

The present disclosure contemplates providing a series of games in addition to the ability of third parties being able to upload their own educational experiences. The series of educational games includes a math game, puzzle game, coloring game, spelling game, quiz game, and a reading game.

When the math game is initialized, a start zone, an avatar, three rows of answer zones, and a result section appear. If the math game is loaded but had not been completed from the previous session, all answer zones, the start zone, and the answer section are reset to their default state, and the result section is repopulated with a new result. To play the math game, a user is presented with an answer and a series of question components. The question components are shown as three rows of answer zones and contain either a number or an operator, which can be combined to provide a solution equal to the answer. The user then selects one answer zone in the first row of answer zones, causing the avatar to move from the start zone to the selected answer zone. The user then selects one answer zone in the second row of answer zones, causing the avatar to move from the first row of answer zones to the selected answer zone in the second row. The user then selects one answer zone in the third row of answer zones, causing the avatar to move from the second row of answer zones to the selected answer zone in the third row. When the user selects question components that equal the presented answer, the user has successfully won the game. This will raise the educational count of the user.

When the puzzle game is initialized, a silhouette of a figure and a number of images that correspond to the silhouette are presented. The user must then map the images to the corresponding part of the silhouette. When all of the pieces have been mapped the game is completed.

The coloring game is played by presenting the user with a colorless image and a series of colors that they can fill the colorless image in with. The game is completed when the user completely colors in the image.

The spelling game is played by first presenting the user with an image of a recognizable object, such as a lion, bat, or car. The user is presented with a plurality of letters that can be used to spell what the image is showing. Preferably, the user is given a finite amount of time to arrive at the correct answers. More preferably, the user will be presented with an avatar which will “jump” to the answer choice selected by the user. That is, if a user were presented with an image of a cow, they would select ‘c’, ‘o’, and ‘w’ from the presented letters. As the user selected each letter, the avatar would jump to their selection. Upon successfully spelling the word used to describe the image, the user's educational count is raised.

The quiz game consists of a simple question-and answer game. The first user or second user will choose a category for the first user to answer questions from. The first user will be presented with a question and will have to select one of multiple provided answers. Upon successfully answering the question the first user's educational count will be raised.

The reading game consists of providing users with an eBook to be read. Upon successfully reading the entire eBook, the user's educational count will be raised. In a highly preferred embodiment, when a user's educational count is equal to their educational quota, the method will prompt them to see if they want to play more games to raise their educational count above their educational quota. Surplus educational counts may be redeemed to obtain real-world items, as discussed below.

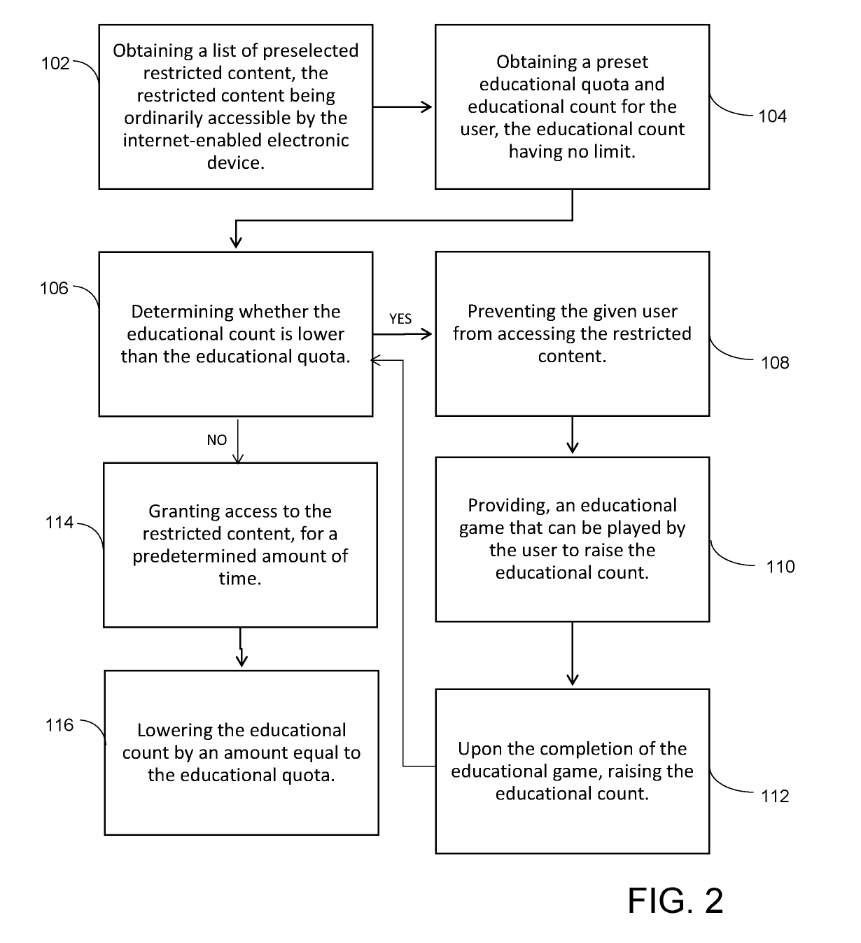

Referring to FIG. 2, an alternative embodiment of the method according to the present disclosure is provided, whereby the user is able to access the restricted content by redeeming their educational count in an amount equal to their educational quota. Similarly, to the method of FIG. 1, the method of FIG. 2 begins with the same steps 102-112. However, upon raising the educational count in step 112, the method proceeds back to step 106 where it determines whether the user's educational count is lower than their educational quota. If so, the method proceeds through steps 108-112 before returning to step 106. If not, the user is granted access to the restricted content in step 114, and then the user's educational count is lowered by an amount equal to their educational quota in step 116. Note that in a preferred embodiment, step 106 does not automatically proceed to step 114. In that preferred embodiment, the user is prompted with a request to redeem their educational count for access to the restricted count. If the user chooses to redeem their educational count then the method proceeds to step 114. Otherwise the method simply terminates.

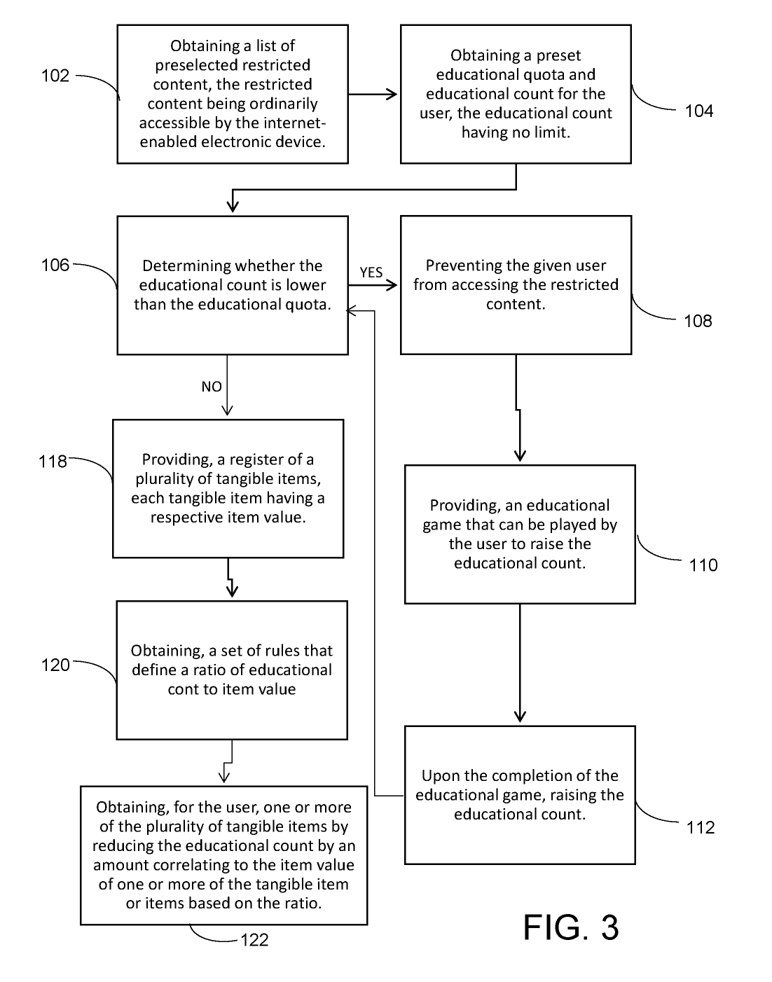

In FIG. 3, yet another alternative embodiment of the method according to the present disclosure is presented. Here, the user is presented with the option to redeem their educational count for tangible goods as opposed to accessing restricted content. Specifically, the method of FIG. 3 begins with the same steps 102-112. Like the method of FIG. 2, this method proceeds from step 112 back to step 106. If the educational count is below the educational quota the method will repeat steps 108-112. If the educational count is above or equal to the educational quota, the method will proceed to step 118 from step 106 where the user is provided with a register of a plurality of tangible items. Each of the items has been assigned an item value. In step 120, the method obtains, a set of rules that define a ratio of educational count to item value. For example, suppose that educational count is measured in terms of “coins,” an in-game currency. In this instance, step 120 would indicate that 100 coins would be required to obtain an item having an item value of 5. Note that these rules are arbitrary and can be set to any value. Preferably, the second user sets this value but other embodiments exist where other parties can set said value. In step 122, a user will reduce (redeem) their educational count in exchange for one or more tangible items based on the ratio defined in step 120. In a highly preferred embodiment, a user will be prompted before the method proceeds from step 106 to step 118. Should a user desire, the method will proceed to step 118 allowing the user to redeem their educational count. However, should a user want to continue to play educational games in order to raise their educational count, they will have the option to terminate the method there. This will allow the user to raise their educational count such that they may earn high value items. For this reason, a user's educational count has no limit. This is a key feature that provides for the improved incentivization of users engaging in educational experiences. The “carrot” of offering real world goods, coupled with the ability to play continually to raise the first user's count provides a strong (and novel) incentive for them to engage in educational experiences. Coupled with the “stick” of having preselected content being restricted, the methods of the present disclosure provide much stronger motivations for users to engage in educational experiences than existing solutions.

The method of FIG. 3 also provides a unique business opportunity for content providers. There exist embodiments of this method where the educational experience is provided by a remote source such as a third party. In such a situation it could be highly beneficial for that third party to also provide the tangible items to be earned by the user. This would provide them with the opportunity to further drive brand engagement and unload surplus tangible items. Other suitable business benefits can also be reaped which capitalize on having a user engage with the third party's educational content in an attempt to obtain tangible items also produced by said third party. Providing this business benefit in an educational context is unique. For example, a company that produces a popular children's television show can upload an educational experience to be played by the first user and can also offer toys of the characters in that show as redeemable tangible items.

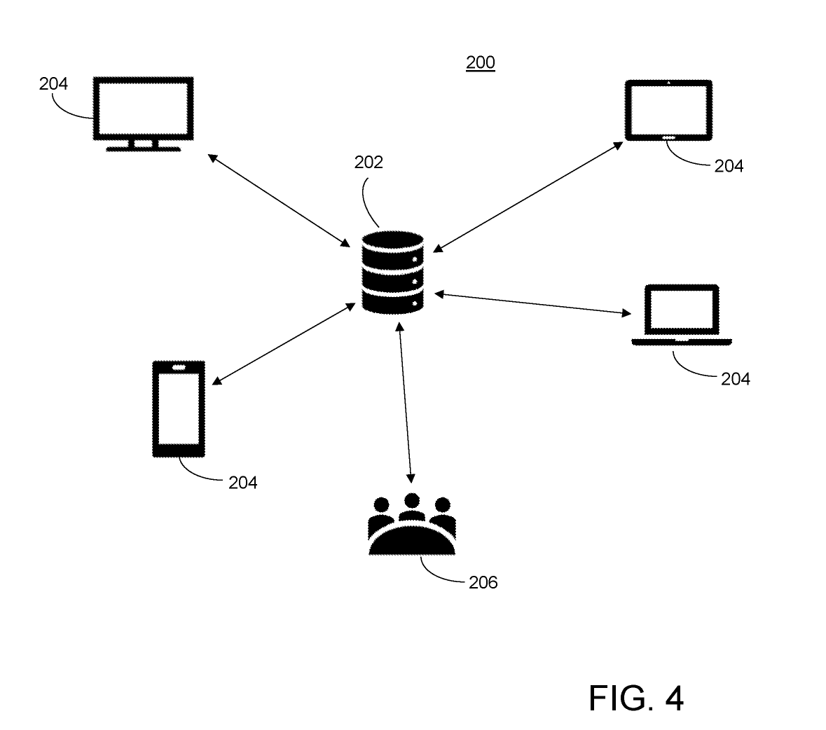

Referring to FIG. 4, an apparatus in accordance with the present disclosure is provided. Here, the apparatus includes a client-server computer 200 which comprises a server computer 202 connected to a plurality of client computers 204. Note that while the term “client computer” is used, any smartphone, tablet, personal computer, smart television or any other “internet of things”-type of device qualifies as a client computer for the purposes of this figure. In this configuration, the server computer 202 stores each user's educational count and educational quota, the register of tangible items where each item has a respective item value, and the set of rules that correlate educational count to item value. The server computer 202 also receives updates to the educational count and the educational quota from the client computer 204. Additionally, the server computer 202 generates and delivers reports containing the first user's engagement with the educational experiences. Such a report will be available to the first user, such as a child, as well as the second user, such as a parent. Here, each of the plurality of client computers 204 provides the at least one educational game which can be used to increase the educational count, identifies what information on the client computer 204 is restricted, locks the restricted content until the educational quota has been met, sends updates to the server computer 202 regarding the educational count and the educational quota. This is helpful when a second user updates the educational quota. The client computers 204 also unlock the restricted content for a predetermined period of time when the educational quota has been successfully redeemed. In a preferred embodiment, the server computer 202 stores a plurality of question-and-answer sets for use in the educational games.

FIG. 4 also shows the interaction of a remote source 206 with the client-server computer system 200. Preferably, the remote source 206 provides a third-party educational experience to be used with the present invention. The sever computer 202 will receive and store this game, and will also sent data pertaining to this third-party game to the client computer 204. Preferably, the remote source 206 will upload their games to the apparatus via an SDK configured to work with the present invention. In some embodiments, the remote source 206 would use the SDK to upload their educational experiences to the apparatus. Preferably, the SDK will connect to the application program interfaces contemplated by the present disclosure and: will allow the remote source 206 to install their educational experiences in the apparatus, add/update links to alternate sources of the educational experiences (such as mirrored hosting); how to track right and wrong answers to questions provided in the educational experience; how to track how long the user spent on a particular question; how to add or remove websites from a blacklist; how to add a problem type; and how to grant/restrict access to the restricted content.

In some embodiments, a user's level of education is entered into the present invention. Preferably, a user's level of education will range from kindergarten through third grade, but the present invention contemplates users of all levels of education.

In a preferred embodiment, the present invention interfaces with an electronic device in the form of a software launcher. This is best for electronic devices running the Android operating system. In another preferred embodiment, the present invention operates by interfacing with an existing enterprise management protocol, such as Apple, Inc.'s “Mobile Device Management” Protocol (“MDM”) to assist in restricting access to content on the first user's mobile device. Here, it may be helpful to completely block available web browsers and to use a web browser configured to work with the present invention in order to blacklist specific websites.

In other embodiments, the said educational experience is presented as an interstitial in said user's use of said at least one software application. That is, a user will be using one of the selected applications without having their access restricted. Then, after a preselected interval, the user will be provided with the educational experience, interstitially. The selected software application will continue to run in the background, but a user will not be able to access it until they complete the educational experience. Optionally, this embodiment will be used when the mobile device is running iOS as an operating system, and will utilize components of the iAd API.

In several embodiments, a parent dashboard is made available to a first user (child) or a second user (parent/guardian). Here, a parent is provided with information and analytics as to the performance of their child or children using the present invention. Parents are able to view, for example, a child's performance over time, in a particular subject, comparisons of the child's performance over time, the time spent on specific applications.

In some embodiments, the present invention includes an “educational progress” screen. Here, a parent can see the progress of a child's progress broken down by subject. Specifically, a parent can see the amount of right answers a child has submitted, the amount of wrong answers a child has submitted, and the average time spent on each question. This can be broken up by subject or can be aggregated and applied to different areas of a child's performance. In other screens of the present invention, a parent may see what specific questions a child was asked, what answer components the child selected, and the time it took the child on that particular question.

It is understood that when an element is referred hereinabove as being “on” another element, it can be directly on the other element or intervening elements may be present therebetween. In contrast, when an element is referred to as being “directly on” another element, there are no intervening elements present.

Moreover, any components or materials can be formed from a same, structurally continuous piece or separately fabricated and connected.

It is further understood that, although ordinal terms, such as, “first,” “second,” and “third,” are used herein to describe various elements, components, regions, layers and/or sections, these elements, components, regions, layers and/or sections should not be limited by these terms. These terms are only used to distinguish one element, component, region, layer and/or section from another element, component, region, layer and/or section. Thus, a “first element,” “component,” “region,” “layer” and/or “section” discussed below could be termed a second element, component, region, layer and/or section without departing from the teachings herein.

Features illustrated or described as part of one embodiment can be used with another embodiment and such variations come within the scope of the appended claims and their equivalents.

Spatially relative terms, such as “beneath,” “below,” “lower,” “above,” “upper” and the like, are used herein for ease of description to describe one element or feature's relationship to another element(s) or feature(s) as illustrated in the figures. It is understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device can be otherwise oriented (rotated 90 degrees or at other orientations) and the spatially relative descriptors used herein interpreted accordingly.

Example embodiments are described herein with reference to cross section illustrations that are schematic illustrations of idealized embodiments. As such, variations from the shapes of the illustrations, for example, of manufacturing techniques and/or tolerances, are to be expected. Thus, example embodiments described herein should not be construed as limited to the particular shapes of regions as illustrated herein, but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

The invention is described above with reference to block and flow diagrams of systems, methods, apparatuses, and/or computer program products according to exemplary embodiments of the invention. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, or may not necessarily need to be performed at all, according to some embodiments of the invention.

These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks. As an example, embodiments of the invention may provide for a computer program product, comprising a computer-usable medium having a computer-readable program code or program instructions embodied therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special purpose hardware and computer instructions.

As the invention has been described in connection with what is presently considered to be the most practical and various embodiments, it is to be understood that the invention is not to be limited to the disclosed embodiments, but on the contrary, is intended to cover various modifications and equivalent arrangements included within the scope of the appended claims. Although specific terms are employed herein, they are used in a generic and descriptive sense only and not for purposes of limitation.

This written description uses examples to disclose the invention, including the best mode, and also to enable any person skilled in the art to practice the invention, including making and using any devices or systems and performing any incorporated methods. The patentable scope of the invention is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

In conclusion, herein is presented a method of incentivizing users to engage in educational experiences. The disclosure is illustrated by example in the drawing figures, and throughout the written description. It should be understood that numerous variations are possible while adhering to the inventive concept. Such variations are contemplated as being a part of the present disclosure.

1. A computerized method for remotely incentivizing a first user to engage in educational experiences on an internet-enabled electronic device in an unrestricted state by restricting access to a list of manually preselected restricted content, comprising:
a. obtaining the list of manually preselected restricted content, the restricted content being ordinarily accessible by the internet-enabled electronic device, wherein the list of preselected restricted content is manually selected by a second user from a list of content that is available on the internet-enabled electronic device;
b. obtaining a set of rules associated with the first user, where the set of rules comprises a preset educational quota and an educational count for the first user, the educational count having no limit;
c. applying the set of rules to determine whether the educational count is lower than the educational quota;
d. transforming the internet-enabled electronic device into a restricted state, where the first user is prevented from accessing the restricted content;
e. generating, an educational game that can be played by the first user to raise the educational count, wherein the educational game is a means for playing a game selected from the group consisting of: a math game, a puzzle game, a spelling game, a quiz game, a coloring game, and a reading game;
f. raising the educational count, upon the completion of the educational game;
g. repeating steps c-f until the educational count is greater than or equal to the preset educational quota;
h. transforming the internet-enabled electronic device into the unrestricted state, where the first user is granted access to the manually preselected restricted content, for a predetermined amount of time;
i. lowering the educational count by an amount equal to the educational quota;
j. providing a register of a plurality of digital items, each digital item having a respective item value, wherein each digital item is provided exclusively by one or more third parties;
k. obtaining the set of rules that define a ratio of educational count to item value; and
l. obtaining for the first user, one or more of the plurality of digital items by reducing the educational count by an amount correlating to the item value of one or more of the plurality of digital items based on the ratio of step k.

2. The method of claim 1, wherein the educational game is imported by a third party.

3. The method of claim 1, wherein the predetermined amount of time is an amount of time set by the second user.

4. The method of claim 3, further comprising the step of:
m. generating, a report containing information pertaining to the first user playing the educational game, the report being available to the second user.

5. An apparatus for remotely incentivizing at least one user to engage in educational experiences, comprising:
a client-server computer system including a server computer connected to a plurality of client computers over a wide area network,
wherein the server computer is programmed to be capable of:
storing an educational count and an educational quota for the at least one user, a register of digital items, each digital item being exclusively provided by one or more third parties and having a respective item value, and a set of rules that define a ratio of educational count to item value;
receiving updates to the educational count and the educational quota from at least one of the plurality of the client computers; and
generating a report containing information pertaining to the at least one user playing an educational game.

6. The apparatus of claim 5, wherein one of the plurality of client computers is programmed to be capable of:
providing the educational game which can be used to increase the educational count;
identifying what information is restricted content from a list of preselected content;
locking the restricted content until the educational quota has been met;
sending updates to the educational count and the educational quota to the server computer; and
unlocking the restricted content for a predetermined period of time when the educational quota has been redeemed.

7. The apparatus of claim 6, wherein the server computer system is programmed to be capable of:
storing a plurality of question-and-answer sets for the educational game.

8. The apparatus of claim 7, wherein the server computer also is programmed to be capable of:
receiving a third-party educational game from a remote source;
storing the third-party educational game;
sending data pertaining to the third-party educational game to one of the plurality of client computers.
